(19) United States
(12) Patent Application Publication
(10) Pub. No.: US 2010/0162792 A1
(43) Pub. Date: Jul. 1, 2010

(54) METHOD FOR DETECTING IMPURITIES IN A GAS TANK

(76) Inventors: Thorsten Allgeier, Untergruppenbach (DE); Kai Oertel, Stuttgart (DE); Ian Faye, Stuttgart (DE); Stephan Leuthner, Leonberg (DE); Jan-Michael Graehn, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/376,907

(22) PCT Filed: Jun. 13, 2007
(86) PCT No.: PCT/EP07/55810

§ 371 Date: Feb. 9, 2009

(30) Foreign Application Priority Data
Aug. 7, 2006 (DE) 102006036785.5

(51) Int. Cl. G01N 7/00

(52) U.S. Cl. 73/31.03

(57) ABSTRACT

The invention relates to a method for detecting impurities in a gas tank having a predefined tank nominal volume, which method includes at least one of the following steps: (a) determining a theoretical pressure drop in the gas tank from a quantity of gas which is actually extracted, and comparing said theoretical pressure drop with a measured pressure drop in the gas tank, wherein a higher measured pressure drop indicates the presence of impurities; and (b) determining a gas volume which is theoretically present in the gas tank from the measured pressure and measured temperature in the gas tank, and comparing the gas volume which is theoretically present in the gas tank with the tank nominal volume in order to determine a volume taken up by impurities which are present.

### PRIOR ART

The invention relates to a method for detecting impurities in a gas tank having a predetermined nominal tank volume.

The storage capacity of a compressed gas tank increases with increasing pressure and decreasing temperature. In the presence of impurities, however, it decreases. Such impurities are for instance oil or water in the compressed gas tank. In the presence of such impurities, the entire empty volume of the tank is no longer available for the gas. For ascertaining the fill level, as it is currently performed, the pressure and the temperature in the gas tank are measured, and from that, a conclusion is drawn about the remaining quantity of gas. However, if the actual capacity of the gas tank is restricted because of existing fluid, a greater gas quantity is calculated than is actually present. If for example the gas tank is used in a gas-powered motor vehicle, then when impurities are present, an overly high tank fill level or an overly long range will be indicated to the driver.

In addition to compressed gas tanks, sorption reservoirs are also used. In sorption reservoirs as well, impurities lead to a decrease in the storage capacity. While in pressure reservoirs only fluid impurities, for instance in the form of long-chain hydrocarbons or water, which form a sump in the reservoir, reduce the available gas volume, in the case of sorption reservoirs, even gaseous impurities can reduce the storage capacity, since such gaseous impurities, such as vapors of water, oil, or other long-chain hydrocarbons, accumulate in the tank. Moreover, the sorbent of a sorption reservoir also has a high affinity for liquids, and in that case the desired capacity is no longer available for the gas to be stored.

### DISCLOSURE OF THE INVENTION

### Advantages of the Invention

A method according to the invention for detecting impurities in a gas tank having a predetermined nominal tank volume includes at least one of the following steps:

(a) determination of a theoretical pressure drop in the gas tank from a quality of gas actually withdrawn, and comparison with a measured pressure drop in the gas tank, where a higher measured pressure drop indicates a presence of impurities;

(b) determination a gas volume theoretically present in the gas tank from the measured pressure and the measured temperature in the gas tank, and comparison with the gas volume theoretically present in the gas tank with the nominal tank volume for determining a volume occupied by impurities that are present.

One advantage of the method of the invention is that in conventional measurement of the pressure and temperature in the gas tank, the actual quantity of gas contained in the tank can be calculated. When the invention is employed in a motor vehicle, the actually still usable quantity of gas can be indicated to the driver.

For determining the theoretical pressure drop and for determining the gas volume theoretically present in the gas tank, the Van der Waals equation for real gases

$$( p + a \cdot {( \frac{n}{V} )}^{2} ) \cdot ( V - n \cdot b ) = n \cdot R \cdot T \qquad ( Equation I )$$

is employed. In it:
p=pressure
V=volume
n=number of molecules
R=gas constant
T=temperature
a=internal pressure of the reservoir gas
b=covolume of the reservoir gas.

The content of the gas tank, calculated by equation I, is equivalent to the storage content with a tank without impurities. The tank volume is assumed to be constant. The gas consumption is determined by determining the gas quantity at two different times. The gas quantity consumed is equivalent to the difference between the gas quantities determined at the two times.

Unlike a pressurized tank, in a sorption reservoir, in which there is additionally a sorbent in the tank, the free gas volume is less.

Alternatively, it is possible to calculate the theoretical pressure drop with the aid of a real gas factor, which describes the deviations of a real gas from an ideal gas, in such a manner that a first time, a quantity of gas m₁ contained in the gas tank is determined, and at a second time, the pressure theoretically prevailing in the gas tank is calculated by the following equation:

$${p}_{2} = Z \cdot \frac{( {m}_{1} - {m}_{v} )}{{M}_{gas}} \cdot \frac{R \cdot {T}_{2}}{{V}_{nenn}} \qquad ( Equation II )$$

in which
m₁=mass in the gas tank at the first time
mᵥ=consumed mass
M_{gas}=molar mass of the gas
T₂=temperature in the gas at the second time
Vₙₑₙₙ=nominal volume of the gas tank
Z=real gas factor.

The real gas factor Z is a substance-specific parameter that describes the deviations of a real gas from the ideal gas and that is dependent on pressure and temperature. For this reason, Z can be stored in memory as a performance graph, for instance in the control unit of an internal combustion engine, and is thus known for every state of the gas tank determined from pressure and temperature.

To determine whether there are impurities in the gas tank, at a first time a gas quantity m₁ contained in the gas tank is determined. At a second time, taking into account the gas quantity m₁ at the first time, the pressure p2, which theoretically prevails in the gas tank at the second time after the withdrawal of a known quantity of gas mᵥ and a new temperature measurement, is calculated. This theoretical pressure is compared with a pressure actually prevailing in the gas tank at the second time. The pressure actually prevailing in the gas tank is determined by a measurement. By means of the in comparison of the calculated theoretical pressure with the actually prevailing pressure, it can be ascertained whether the nominal volume of the gas tank is actually available to its full extent for the gas. If the pressure measured at the second time is less than the calculated pressure, the gas tank has impurities.

If the method of the invention is used in a gas-powered motor vehicle, then it is preferable that the real gas factor is stored in memory as a function of pressure and temperature in a performance graph in a control unit of an internal combustion engine. In this case, the control unit can easily access the real gas factor and the pressure theoretically prevailing in the gas tank can be calculated.

When the method of the invention is used in a motor vehicle, the quantity of gas actually consumed is preferably for example determined from data for an internal combustion engine. The data from which the quantity actually consumed is determined are the injection time, rpm of the engine, injection pressure, and injection temperature. The injection time is the period of time in which gas is injected into a cylinder of the engine during one stroke.

With the data of the engine, the quantity of gas actually consumed for one cylinder of an internal combustion engine can for instance be calculated by the following equation:

$${\dot{m}}_{KS} = {\dot{m}}_{KS 0} \cdot \sqrt{\frac{{T}_{0}}{{T}_{KS}}} \cdot \frac{{p}_{Ks}}{{p}_{0}} \cdot \frac{{t}_{i}}{( 120000 / {n}_{mot} )} \qquad ( Equation III )$$

in which
.m_{KS}=flow rate per cylinder in kg/h
.m_{KS0}=stationary flow rate through the fully opened injector in kg/h
T₀=reference temperature=273 K
T_{KS}=absolute gas temperature in K
p₀=reference pressure=1.013 bar
p_{KS}=gas pressure at the injector in bar
tᵢ=injection time in ms
nₘₒₜ=engine rpm.

To determine the total flow rate for all the cylinders of the engine, the flow rate calculated according to equation III must be multiplied by the number of cylinders.

For determining the gas quantity consumed, the gas flow rate calculated by equation III can be integrated over time.

In an alternative embodiment, the gas mass consumed by the engine can also be ascertained by way of detecting the air mass required for combustion and via the air number λ. The actually delivered air mass is measured with a hot-film air flow rate sensor, for example, and is present in the form of information in the control unit of the engine. The ratio of the actual air-fuel ratio to the stoichiometric air-fuel ratio is measured via a λ sensor from the oxygen concentration in the exhaust gas. To attain an air number λ=1, for instance for the complete combustion of 1 kg of methane, 17.2 kg of air are required. The air quantity of gases required for the complete combustion can be ascertained in a simple way. This is known to one skilled in the art and is not the subject of the present invention.

In the embodiment in which the data of the engine are the air mass and the air number, the quantity of gas actually consumed is calculated from

$${m}_{KS} ( tats . ) = \frac{{m}_{Luft} ( tats . ) \cdot {m}_{KS} ( st \ddot{o} ch . )}{λ \cdot {m}_{Luft} ( st \ddot{o} ch . )} \qquad ( Equation IV )$$

in which
m_{KS}(tats.)=fuel mass actually consumed
m_{KS}(stöch)=fuel mass stoichiometrically required
m_{Luft}(tats.)=air mass actually consumed
m_{Luft}(stöch.)=air mass stoichiometrically required
λ=air number.

Besides the calculation of the gas quantity withdrawn from the gas tank with the aid for instance of parameters from an internal combustion engine, it is also possible to determine the gas quantity withdrawn for instance using a gas flow measuring instrument. This is appropriate for instance for determining impurities that occur in a storage tank of a gas filling station. Since in a gas filling station of this kind only gas is dispensed to a gas tank of a motor vehicle from the storage tank, it is not possible to calculate the quantity of gas withdrawn using consumption parameters.

By forming the difference between the actual consumption, which was calculated or measured from the parameters of the internal combustion engine, and the theoretical volume determined using equation I, the effective storage volume of the gas tank, which has been reduced by the impurity, can be determined.

According to the invention, a distinction can be made between a qualitative detection of a reduced tank volume and a quantitative determination.

Qualitative information that impurities are present is on hand for instance if the measured pressure drop proceeds faster than the pressure drop that results from the quantity of gas actually withdrawn. To that end, from equation I, the pressure theoretically prevailing in the gas tank is calculated. For n, which the number of molecules, the quantity that results by recalculation from the quantity of gas actually withdrawn is used. To that end, for a determined mass of gas withdrawn, for instance, the gas mass can be divided by the molar mass of the gas.

From equation I, for a known quantity of gas withdrawn, a pressure is found that would have to prevail in the gas tank if there were no impurities in the gas tank. However, if the gas tank does contain impurities, then the pressure in the gas tank drops more sharply. Thus the measured pressure is lower than the calculated pressure.

To obtain the simplest possible calculation, which can be used for instance in a control unit of an internal combustion engine as well, it is preferred that instead of the Van der Waals equation (equation I), the calculation be done with the aid of the real gas factor, also called the compressibility factor. For the real gas factor, the following equation applies:

$$Z = \frac{p \cdot V}{n \cdot R \cdot T} \qquad ( Equation V )$$

in which
Z is the real gas factor,
p is the pressure,
V is the volume,
n is the number of molecules of the gas,
R is the gas constant, and
T is the temperature.

Z is a substance-specific variable, which describes the deviations of a real gas from the ideal gas. Z is dependent on the pressure and the temperature. The real gas factor Z can be stored in memory as a performance graph in a control unit of an internal combustion engine and as a result is known for every state of the gas tank that is determined by pressure and temperature.

Now, if for a predetermined first time the quantity of gas m₁ present in the tank is determined, and at a second time the pressure p2 is calculated that results from the withdrawal of a known quantity of gas mᵥ, and for calculation the temperature at the second time is used, then the calculated pressure can be can be compared with the actual pressure. In this way, it can be ascertained whether the nominal volume of the tank was in fact fully available for the gas.

To determine the quantitative impurity in the gas tank, it is necessary to determine the volume of the gas that would have to be present, given cumulative gas consumption and a measurement of pressure and temperature and taking the real gas law (equation I) into account, and this would have to be compared with the actual nominal tank volume Vₜₐₙₖ. The difference between the gas volume V_{gas} and the nominal gas volume Vₜₐₙₖ then determines the quantity of impurities in the tank. A tolerance may be subtracted as applicable.

With the aid of the method of the invention, it is possible for instance by comparison with an adjustable variable that takes system tolerances into account to warn the driver of a gas-powered motor vehicle if the impurities are impermissibly great and to inform him that the range is thus reduced. This can be done with the aid of a warning light, for instance. It is also possible, by means of a suitable entry in the supplementary memory of the control unit, to tell the driver that the tank requires cleaning.

### BRIEF DESCRIPTION OF THE DRAWINGS

Exemplary embodiments of the invention are shown in the drawing and described in further detail in the ensuing description.

The sole FIGURE of the drawing shows a qualitative course of the measured pressure with a clean tank and a dirty tank.

### ELEMENTS OF THE INVENTION

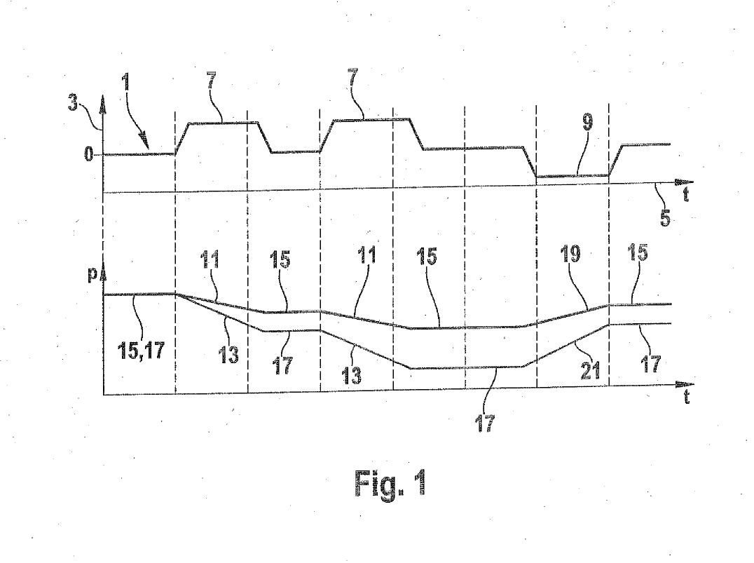

In the upper graph in FIG. 1, a curve 1 is shown that represents the instantaneous consumption as a function of time. The consumption is plotted on the ordinate 3, and the time is plotted on the abscissa 5. As soon as gas is withdrawn from the gas tank, the curve deflects upward. This is represented in the drawing by reference numeral 7. A downward deflection of the curve, as indicated by reference numeral 9, means filling of the gas tank.

The lower graph in the drawing shows the measured pressure in the gas tank for the instantaneous use shown in the upper graph. At the beginning, the tank is full; the pressure p shown on the ordinate has assumed a maximum value. As soon as gas is withdrawn from the gas tank, the measured pressure p in the gas tank drops. As the withdrawal is ended, or in other words the instantaneous consumption as a function of time amounts to zero, the measured pressure remains constant in the tank. The ranges within which the pressure drops from gas withdrawal are indicated by reference numeral 11 for a tank without impurities and reference numeral 13 for a tank with impurities. The ranges of constant pressure, that is, the ranges at the times when no gas is being withdrawn from the gas tank, are indicated by reference numeral 15 for a clean tank and reference numeral 17 for a dirty tank.

As can also be seen in the drawing, the pressure in the gas tank increases again when the gas tank is filled. The pressure increase is indicated by reference numeral 19 for a clean gas tank and reference numeral 21 for a dirty tank.

It can be seen from the drawing that for the same withdrawal of gas, the pressure in the gas tank drops more sharply for a dirty tank than for a clean tank. The result is that an overly high consumption, compared to the actual consumption, is calculated using pressure and temperature. This error can be determined and thus compensated for by the method of the invention.

As soon as the error exceeds a predetermined set-point value, the driver can for instance be told that cleaning of the gas tank is necessary.

1-11. (canceled)

12. A method for detecting impurities in a gas tank having a predetermined nominal tank volume, which includes at least one of the following steps:
(a) determination of a theoretical pressure drop in the gas tank from a quality of gas actually withdrawn, and comparison with a measured pressure drop in the gas tank, where a higher measured pressure drop indicates a presence of impurities;
(b) determination a gas volume theoretically present in the gas tank from the measured pressure and the measured temperature in the gas tank, and comparison with the gas volume theoretically present in the gas tank with the nominal tank volume for determining a volume occupied by impurities that are present.

13. The method as defined by claim 12, wherein for determining the theoretical pressure drop and for determining the gas volume theoretically present in the gas tank, the Van der Waals equation for real gases
$$( p + a \cdot {( \frac{n}{V} )}^{2} ) \cdot ( V - n \cdot b ) = n \cdot R \cdot T$$
is employed.

14. The method as defined by claim 12, wherein the theoretical pressure drop is calculated with the aid of a real gas factor, which describes the deviations of a real gas from an ideal gas, in such a manner that a first time, a quantity of gas m₁ contained in the gas tank is determined, and at a second time, the pressure theoretically prevailing in the gas tank is calculated by the following equation:
$${p}_{2} = Z \cdot \frac{( {m}_{1} - {m}_{v} )}{{M}_{gas}} \cdot \frac{R \cdot {T}_{2}}{{V}_{nenn}}$$
in which
m₁=mass in the gas tank at the first time
mᵥ=consumed mass
M_{gas}=molar mass of the gas
T₂=temperature in the gas at the second time
Vₙₑₙₙ=nominal volume of the gas tank
Z=real gas factor.

15. The method as defined by claim 14, wherein the real gas factor is stored in memory as a function of pressure and temperature in a performance graph in a control unit of an internal combustion engine.

16. The method as defined by claim 12, wherein the quantity of gas actually consumed is determined from data for an internal combustion engine.

17. The method as defined by claim 13, wherein the quantity of gas actually consumed is determined from data for an internal combustion engine.

18. The method as defined by claim 14, wherein the quantity of gas actually consumed is determined from data for an internal combustion engine.

19. The method as defined by claim 15, wherein the quantity of gas actually consumed is determined from data for an internal combustion engine.

20. The method as defined by claim 16, wherein the data for the internal combustion engine are injection time, rpm, injection pressure, and injection temperature.

21. The method as defined by claim 20, wherein the quantity of gas actually consumed for one cylinder of an internal combustion engine is calculated by the following equation:
$${\dot{m}}_{KS} = {\dot{m}}_{KS 0} \cdot \sqrt{\frac{{T}_{0}}{{T}_{KS}}} \cdot \frac{{p}_{Ks}}{{p}_{0}} \cdot \frac{{t}_{i}}{( 120000 / {n}_{mot} )}$$
in which
\dot{m}_{KS}=flow rate per cylinder in kg/h
\dot{m}_{KS0}=stationary flow rate through the fully opened injector in kg/h
T₀=reference temperature=273 K
T_{KS}=absolute gas temperature in K
p₀=reference pressure=1.013 bar
p_{KS}=gas pressure at the injector in bar
t₁=injection time in ms
nₘₒₜ=engine rpm.

22. The method as defined by claim 16, wherein the data of the engine are the air mass and the air number, and the quantity of gas actually consumed is calculated from
$${m}_{KS} ( tats . ) = \frac{{m}_{Luft} ( tats . ) \cdot {m}_{KS} ( st \ddot{o} ch . )}{λ \cdot {m}_{Luft} ( st \ddot{o} ch . )}$$
in which
m_{KS}(tats.)=fuel mass actually consumed
m_{KS}(stöch.)=fuel mass stoichiometrically required
m_{Luft}(tats.)=air mass actually consumed
m_{Luft}(stöch.)=air mass stoichiometrically required
λ=air number.

23. The method as defined by claim 12, wherein the gas quantity actually consumed is determined by means of a gas flow measuring instrument.

24. The method as defined by claim 13, wherein the gas quantity actually consumed is determined by means of a gas flow measuring instrument.

25. The method as defined by claim 14, wherein the gas quantity actually consumed is determined by means of a gas flow measuring instrument.

26. Use of the method as defined claim 12 for determining impurities in the gas tank of a gas-powered motor vehicle.

27. Use of the method as defined claim 12 for determining impurities in a storage tank at a gas filling station.

28. Use of the method as defined claim 13 for determining impurities in a storage tank at a gas filling station.

29. Use of the method as defined claim 14 for determining impurities in a storage tank at a gas filling station.

30. Use of the method as defined claim 23 for determining impurities in a storage tank at a gas filling station.
